(19) United States
(12) Patent Application Publication
(10) Pub. No.: US 2009/0233218 A1
(43) Pub. Date: Sep. 17, 2009

(54) METHOD FOR PREPARING TONER

(76) Inventor: Satoshi OGAWA, Nara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/404,911

(22) Filed: Mar. 16, 2009

(30) Foreign Application Priority Data
Mar. 17, 2008 (JP) 2008-066968

(51) Int. Cl. G03G 5/00

(52) U.S. Cl. 430/137.2

(57) ABSTRACT

A method for preparing a toner including as toner components at least a binder resin, a pigment and a dispersant for the pigment. The method includes firstly mixing at least the pigment and the dispersant to prepare a first mixture; secondly mixing the first mixture with the other toner components including at least the binder resin to prepare a second mixture; kneading the second mixture using an open roll kneader; pulverizing the kneaded material to prepare a colored powder; and classifying the colored powder to prepare particles of the toner, wherein the binder resin includes a polyester resin, and the dispersant includes a fatty acid ester.

### BACKGROUND OF THE INVENTION

1. Field of the Invention

The present invention relates to a method for preparing a toner, and more particularly to a method for preparing a toner for use in producing full color images.

2. Discussion of the Background

Image forming apparatus using electrophotography or electro printing have been used for copiers, printers and facsimiles. For example, electrophotographic image forming apparatus produce images by performing the following processes:
(1) An electrostatic latent image is formed on a photoreceptor, which serves as an image bearing member and includes a photosensitive layer including a photosensitive material, according to image information utilizing one of a variety of image forming processes (such as combinations of charging and light irradiation process) (latent image forming process);
(2) The electrostatic latent image is developed with a developer, which is supplied from a developing device and includes a toner, to form a visual image (i.e., toner image) on the image bearing member (developing process);
(3) The toner image is transferred onto a receiving material (such as paper sheets) (transferring process); and
(4) The toner image is fixed on the receiving material using a fixing device, which applies heat and pressure thereto (fixing process).

Toner is used for such image forming apparatus to visualize electrostatic latent images formed on an image bearing member of the apparatus. Specific examples of the dry developing methods for use in such image forming apparatus include powder cloud methods, cascade methods, magnetic brush methods, etc. Among these developing methods, magnetic brush methods are broadly used because of having advantages such that controlling of the developing operation is easy; and high quality toner images can be produced. Magnetic brush methods are broadly classified into one-component developing methods, which use only a toner (i.e., one component developer) including a magnetic material and form a magnetic brush of the toner to develop electrostatic images therewith; and two-component developing methods, which use a toner and a carrier (e.g., particulate magnetic materials) and form a magnetic brush of the developer to develop electrostatic images therewith. In both the developing methods, toner particles in the magnetic brush are charged so as to have a predetermined amount of charge, and the charged toner particles are attracted by an electrostatic latent image formed on an image bearing member due to the coulomb force, thereby forming a toner image on the image bearing member.

Toner typically includes a binder resin and a colorant, which is dispersed in the binder resin, as main components. Synthetic resins having a proper charging property and a proper binding property, such as styrene resins and polyester resins, are typically used as the binder resin, and organic or inorganic colorants, such as carbon blacks, are typically used as the colorant.

The toner image thus formed on an image bearing member is transferred onto a receiving material, and the transferred toner image is then fixed thereon upon application of heat and pressure thereto, resulting in formation of a visual image.

A full color image can be produced by overlaying a cyan toner image, a magenta toner image, and a yellow toner image on a receiving material. When human eyes recognize a full color image by catching light absorbed by or reflected from the single toner layers and overlaid toner layers.

Recently, in electrophotographic reproduction technology, full color image formation becomes mainstream instead of monochrome (i.e., black and white) image formation. With popularization of full color image forming apparatus, the full color image forming apparatus are used for various purposes, and the quality requirement for full color images becomes severer and severer. For example, a need exists for electrophotographic full color images having higher image qualities than photograph images. In order to fulfill such a high image quality requirement, a need for toner having a small particle diameter and good color reproducibility increases. When forming high quality images using a toner having a small particle diameter, the amount of toner particles present on non-image areas (i.e., background areas) of a receiving material has to be decreased to avoid soiling of the non-image areas (i.e., to avoid a background development problem). In this case, it is necessary to decrease the amount of toner particles present on image areas of the receiving material.

In order to reproduce a high density color image using a smaller amount of toner particles, the content of the colorant included in the toner has to be increased. In order to impart good coloring property (i.e., good tinting power) to a toner including a colorant at a high concentration, the colorant has to be well dispersed in the toner (i.e., the dispersion conditions of the colorant in the toner has to be improved). When a colorant is not well dispersed in a toner, the reflectance of the toner in the reflection wavelength region of the toner decreases, resulting in deterioration of chroma of the toner image. In addition, since the transparency of the toner deteriorates, the color reproducibility of secondary color images (such as red, green and blue images) deteriorates. Therefore, an increasing need exists for a technology of well dispersing a colorant (such as pigments) in a binder resin at a high concentration in order to produce high quality full color images having good color reproducibility.

As for pigment dispersing technology, methods using a so-called master batch, which is prepared by kneading a pigment and a binder resin together with a dispersant for the pigment, have been typically used. In the methods, a pigment is previously wet with a binder resin, and then a shearing force is applied to the wet pigment to prepare a master batch of the pigment in which the pigment is dispersed in the binder resin at a high concentration. The thus prepared master batch is then diluted with the binder resin and/or other binder resins. By using the methods, pigments can be well dispersed in binder resins. However, the methods have drawbacks such that since the master batch preparation process is an additional process, the energy consumption of the methods increases, the yield of the toner decreases, and the costs of the toner increase. Therefore, a need exists for a toner preparation method including no master batch preparation process.

In attempting to improve dispersion conditions of pigments in binder resins using dispersants, a published unexamined Japanese patent application No. (hereinafter referred to as JP-A) 63-241563 describes that by using a fatty acid ester as a dispersant for a pigment, the pigment can be well dispersed in a binder resin. However, in this technique, a fatty acid ester is merely mixed with other toner components such as binder resins and pigments. Therefore, it is necessary for the method to further improve dispersion conditions of pigments.

In addition, methods of improving dispersion conditions of pigments in binder resins by treating the surface of the pigments with a material have been proposed. For example, JP-A 58-108256 discloses to treat surface of pigments with rosin. In addition, JP-A 02-052362 discloses to use amine-modified polyester resins as treatment agents for treating surface of pigments. It is described therein that by using such polyester resins, pigments can be well dispersed in binder resins. However, it is necessary for these methods to perform an additional process (i.e., a surface treatment process) similar to the master batch preparation process. Therefore, the methods have the same drawbacks as mentioned above in the methods using a master batch.

Because of these reasons, a need exists for a method for preparing a toner, in which a pigment is well dispersed and which can produce high quality full color images, without performing an additional process such as master batch preparation processes and surface treatment processes.

### SUMMARY OF THE INVENTION

As an aspect of the present invention, a method for preparing a toner including as toner components at least a binder resin, a pigment and a dispersant for the pigment is provided. The method includes:

firstly mixing at least the pigment and the dispersant to prepare a first mixture;

secondly mixing the first mixture with the other toner components including at least the binder resin to prepare a second mixture;

kneading the second mixture using an open roll kneader;

pulverizing the kneaded second mixture to prepare a colored powder; and

classifying the colored powder to prepare particles of the toner,

wherein the binder resin includes a polyester resin, and the dispersant includes a fatty acid ester.

### DETAILED DESCRIPTION OF THE INVENTION

The present invention relates to a method for preparing a toner for use in forming full color images, which includes as toner components at least a binder resin, a pigment and a dispersant for the pigment. The method includes:

firstly mixing at least the pigment and the dispersant to prepare a first mixture;

secondly mixing the first mixture with the other toner components including at least the binder resin to prepare a second mixture;

kneading the second mixture using an open roll kneader;

pulverizing the kneaded second mixture to prepare a colored powder; and

classifying the colored powder to prepare particles of the toner.

In this regard, the binder resin includes a polyester resin, and the dispersant includes a fatty acid ester.

The reason why the pigment and the dispersant are mixed in the first mixing process is that the dispersant can be well adsorbed physically to the pigment. Namely, when the thus prepared first mixture is mixed with the other toner components including the binder resin, the dispersant is present in the vicinity of particles of the pigment. When such a second mixture is kneaded upon application of heat thereto, at first the dispersant is melted, and thereby the surfaces of the pigment particles are coated with the dispersant (i.e., the surfaces of the pigment particles are wet with the dispersant). By wetting the surfaces of the pigment particles with the dispersant, the surface free energy of the pigment (which causes aggregation of the pigment) decreases, and thereby the pigment can be easily dispersed in the binder resin even by a low shearing force. In other words, the pigment can be better dispersed in the binder resin even by the same shearing force.

In addition, since a polyester resin is used as a binder resin of the toner, images formed by the toner have a good combination of chroma and color reproducibility because polyester resins tend to have high transparency and low turbidity.

The reason why fatty acid esters are preferably used as the pigment dispersant is not yet determined, but is considered to be as follows. Specifically, because of having an ester group, fatty acid esters have good wettability to pigments. In addition, since both the dispersant (fatty acid esters) and the binder resin (polyester resins) have a carboxyl group, the dispersant can be well compatible with the binder resin. Therefore, the pigment wet with the dispersant can be well dispersed in the binder resin.

Further, the reason why an open roll kneader is used for kneading the second mixture is as follows. Specifically, by using an open roll kneader, the kneading operation can be performed while externally radiating the heat generated by the kneading operation. Therefore, the kneading operation can be performed at a relatively low temperature. By performing the kneading operation at a relatively low temperature, the kneaded mixture can maintain a highly elastic state, and thereby a high shearing force can be applied to the kneaded mixture.

In the toner preparation method of the present invention, the dispersant preferably has a melting point lower than the softening point of the binder resin. In this case, the dispersant melts before the binder resin is softened, and thereby the dispersant can cover the surfaces of particles of the pigment. Therefore, the dispersing effect of the dispersant can be enhanced, and thereby the pigment can be well dispersed in the binder resin.

In addition, the dispersant preferably has a melting point of from 70 to 105° C. In this case, the dispersant is present in the binder resin as domains while partially dissolving therein. When the kneaded second mixture having such a configuration is pulverized, the kneaded mixture is mainly pulverized at the interfaces between the dispersant domains and the binder resin. Therefore, the dispersant tends to be present on the surfaces of the resultant toner particles. In this case, if the melting point of the dispersant is too low, the dispersant present on the surfaces of the toner particles deteriorates the preservability of the toner (which causes an aggregation problem in that the toner particles aggregate at relatively high temperatures), and causes a defective charging problem in that the toner particles cannot be sufficiently charged particularly under high humidity conditions and the background development problem in that the background of images is soiled with toner particles due to insufficient charging of the toner particles. Thus, when the melting point of the dispersant is too low, the charging property and preservability of the resultant toner deteriorate. In contrast, when the melting point of the dispersant is too high, the dispersant cannot evenly cover the surfaces of the pigment particles, and thereby the pigment cannot be well dispersed in the binder resin.

Further, the added amount of the dispersant is preferably 0.5 to 5 parts by weight per 100 parts by weight of the binder resin. When the added amount of the dispersant is too small, the dispersant cannot evenly cover the surfaces of the pigment particles, and thereby the pigment cannot be well dispersed in the binder resin. In contrast, when the added amount is too large, the amount of the dispersant present on the surfaces of the toner particles increases, thereby deteriorating the preservability and charging property of the toner, resulting in occurrence of the aggregation problem and the background development problem.

Furthermore, the dispersant preferably has an acid value of from 5 to 30 mgKOH/g. When the acid value of the dispersant is too low, the dispersant cannot be properly dissolved in the binder resin, and thereby the dispersing effect of the dispersant cannot be well produced (i.e., the pigment cannot be well dispersed in the binder resin. In contrast, when the acid value of the dispersant is too high, the dispersant becomes highly hygroscopic, and thereby the dispersant present on the surface of the toner particles deteriorates the preservability and charging property of the toner, resulting in occurrence of the aggregation problem and the background development problem.

Furthermore, the dispersant mixed with the pigment preferably has a volume average particle diameter of from 5 to 20 μm. When the volume average particle diameter is too small, the dispersant cannot be well mixed with the other toner components such as the pigment and the binder resin, and thereby the pigment cannot be well dispersed in the binder resin. In contrast, when the volume average particle diameter is too large, the dispersant cannot be well adsorbed to the pigment. This is because the larger particle diameter a particle of the dispersant has, the smaller surface area the particle has. In this case, the dispersant cannot be well adsorbed to the pigment.

Furthermore, the binder resin preferably has an acid value of from 5 to 30 mgKOH/g. When the acid value of the binder resin is too low, the dispersant cannot be properly dissolved in the binder resin, and thereby the dispersing effect of the dispersant cannot be well produced (i.e., the pigment cannot be well dispersed in the binder resin. In contrast, when the acid value of the binder resin is too high, the toner itself becomes highly hygroscopic, thereby deteriorating the preservability and charging property of the toner, resulting in occurrence of the aggregation problem and the background development problem.

Furthermore, the pigment is preferably C.I. Pigment Red 122 (for magenta toner), C.I. Pigment Blue 15 (for cyan toner) or C.I. Pigment Yellow 74 (for yellow toner). In this case, the toner has a good combination of magenta, cyan and yellow color reproducibility (a wide range of color reproducibility) and half tone reproducibility. In addition, when such pigments are well dispersed, the secondary color images (such as blue, green and red color images) can also be well reproduced. Namely, when a toner kit including these three toners is used, full color images having good color reproducibility can be produced. Further, these pigments have a good combination of safeness and weather resistance.

Next, the toner preparation method of the present invention will be explained in detail.

The toner preparation method includes mixing, kneading, cooling, pulverizing (preferably a combination of crushing and pulverizing), and classifying processes. The method optionally includes an external additive adding process, in which toner particles prepared by the classification process are mixed with an external additive.

In the mixing process, at least a pigment and a dispersant for the pigment are firstly mixed, and then the first mixture is mixed with the other toner components including a binder resin as an essential component, and including other components such as charge controlling agents and release agents. The mixer for use in mixing the toner components is not particularly limited, and any known mixers, which can mix such toner components as mentioned above can be used. Among these mixers, mixers having a rotor rotated at a high revolution and a jacket for cooling the mixers can be preferably used. Specific examples of such mixers include HENSCHEL MIXER mixers from Mitsui Mining Co., Ltd.

In the kneading process, the mixed toner components are melted and kneaded upon application of heat thereto. In this case, open roll kneaders having at least one pair of two rollers provided so as to be close to each other are preferably used. Among these open roll kneaders, continuous open two-roll kneaders are more preferably used because of having simple structure and high productivity.

The gap between the two rollers can be freely set. In addition, the two rollers may be parallel or non-parallel to each other. Specifically, by forming a wider gap at the exit of the kneader than that at the entrance thereof from which the toner component mixture is fed, a higher shearing force can be applied to the toner component mixture at the entrance than the shearing force at the exit. In this case, kneading of the toner component mixture is mainly performed in the former portion of the kneader and melt-mixing of the mixture is mainly performed in the latter portion of the kneader. In addition, generation of heat caused by kneading can be decreased in the latter portion, resulting in further enhancement of the kneading effect. It is preferable that one of the two rollers is a heat roller through which a heating medium is flown, and the other roller is a cooling roller through which a cooling medium is flown.

The temperature of the heating medium is preferably controlled so as to be within ±30° C. of the softening point of the binder resin. The structure, size and constituent material of the rollers are not particularly limited. In addition, the conditions of the surface of the rollers are not particularly limited. For example, the surface of the rollers may be smooth, waved or rough surface. The circumferential velocity of the rollers is preferably from 2 to 100 m/min, and the ratio of the revolution of the cooling roller to the revolution of the heating roller is preferably from 1/10 to 9/10. By properly setting the revolution ratio, the kneading force can be controlled so as to be the predetermined kneading force.

The binder resin includes at least a polyester resin, which preferably has an acid value of from 5 to 30 mgKOH/g. Polyester resins having such an acid value can be easily obtained. By using a polyester resin as a binder resin, the thermal properties of the toner can be easily controlled. Therefore, the toner is preferably used for forming full color toner images.

Suitable polyester resins include polyester resins prepared by reacting a polyhydric alcohol with a polycarboxylic acid. Specific examples of the polyhydric alcohol include ethylene glycol, 1,2-propylene glycol, 1,3-propylene glycol, 1,4-butanediol, 2,3-butanediol, diethyleneglycol, triethylene glycol, 1,5-pentanediol, 1,6-hexanediol, neopentyl glycol, 1,4-cyclohexane dimethanol, dipropylene glycol, polyethylene glycol, polypropylene glycol, bisphenol A, hydrogenated bisphenol A, alkylene oxide adducts of bisphenol A (such as polyoxyethylenated bisphenol A, and polyoxypropylenated bisphenol A), etc.

In addition, polyhydric alcohols having three or more hydroxyl groups can be used so that the resultant polyester resins are nonlinear to such an extent as to include no tetrahydrofuran-insoluble components. Specific examples of the polyhydric alcohols having three or more hydroxyl groups include glycerin, sorbitol, 1,2,3,6-hexanetetraol, 1,4-sorbitan, pentaerythritol, 1,2,4-butanetriol, 1,2,5-pentanetriol, 2-methylpropanetriol, 2-methyl-1,2,4-butanetriol, trimethylolethane, trimethylolpropane, 1,3,5-trihydroxymethylbenzene, etc.

Specific examples of the polycarboxylic acids include dicarboxylic acids such as maleic acid, fumaric acid, mesaconic acid, citraconic acid, itaconic acid, glutaconic acid, phthalic acid, terephthalic acid, isophthalic acid, cyclohexane dicarboxylic acid, malonic acid, succinic acid, adipic acid, sebacic acid, glutaric acid, and alkylsuccinic acid (e.g., n-octylsuccinicacid, and n-dodecenylsuccinic acid); anhydrides and alkyl esters of such dicarboxylic acids; etc.

The binder resin preferably has an acid value of from 5 to 30 mgKOH/g.

Any known colorants having yellow, magenta, cyan or black color can be used for the toner.

Specific examples of the magenta colorants include C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10, C.I. Disperse Red 15, etc. Among these colorants, quinacridone type pigments are preferably used in view of color tone. Among the quinacridone type pigments, C.I. Pigment Red 122 is more preferably used.

Specific examples of the cyan colorants include C.I. Pigment Blue 15, C.I. Pigment Blue 16, C.I. Solvent Blue 55, C.I. Solvent Blue 70, C.I. Direct Blue 25, C.I. Direct Blue 86, etc. Among these colorants, copper phthalocyanine pigments are preferably used in view of color tone. Among the copper phthalocyanine pigments, β-form phthalocyanine pigments such as C.I. Pigment Blue 15:3 and C.I. Pigment Blue 15:4 are more preferably used.

Specific examples of the yellow colorants include Hansa monoazo yellow pigments such as C.I. Pigment Yellow 1, C.I. Pigment Yellow 3, C.I. Pigment Yellow 74, C.I. Pigment Yellow 97 and C.I. Pigment Yellow 98; benzimidazolone monoazo yellow pigments such as C.I. Pigment Yellow 151, C.I. Pigment Yellow 154 and C.I. Pigment Yellow 174; benzimidazolone disazo yellow pigments such as C.I. Pigment Yellow 180; disazo yellow pigments such as C.I. Pigment Yellow 12, C.I. Pigment Yellow 15, C.I. Pigment Yellow 17 and C.I. Pigment Yellow 83; condensed azo pigments such as C.I. Pigment Yellow 93, C.I. Pigment Yellow 94 and C.I. Pigment Yellow 95; isoindolinone pigments such as C.I. Pigment Yellow 173 and C.I. Pigment Yellow 185; etc. In addition, inorganic pigments such as yellow iron oxide and loess can also be used. Further, yellow dyes such as nitro dyes (e.g., C.I. Acid Yellow 1); and oil soluble dyes (e.g., C.I. Solvent Yellow 2, C.I. Solvent Yellow 6, C.I. Solvent Yellow 14, C.I. Solvent Yellow 15, C.I. Solvent Yellow 19 and C.I. Solvent Yellow 21) can also be used. Among these yellow colorants, azo pigments such as C.I. Pigment Yellow 74 are preferably used in view of safeness, tinting power and color tone.

Suitable black colorants include carbon blacks. Specific examples of carbon blacks include channel blacks, gas furnace blacks, oil furnace blacks, acetylene blacks, etc.

The added amount of the colorant is determined depending on the variables such as particle diameter and tinting power of the colorant used; molecular weight, viscosity and softening point of the binder resin used; and the targeted color tone and chroma of color images, and is generally from 3 to 29 parts by weight, and preferably from 5 to 15 parts by weight, per 100 parts by weight of the binder resin used.

The dispersant for use in preparing the toner (i.e., for use in dispersing a colorant in a binder resin) is a fatty acid ester. Fatty acid esters are typically prepared by subjecting a fatty acid to an oxidation refinement and then reacting the fatty acid with an alcohol. Fatty acid esters used for the method of the present invention are not particularly limited. However, solid fatty acid esters having a melting point of not lower than 40° C. are preferably used. In this regard, the melting point is determined by differential scanning calorimetry (DSC) and is defined as the temperature at which an endothermic peak is observed. Specific examples thereof include fatty acid esters having 12 or more carbon atoms, such as esters of lauric acid, myristic acid, palmitic acid, stearic acid, behenic acid, lignoceric acid, and montanic acid. Among these fatty acid esters, montanic acid esters having a melting point of not lower than 80° C. are more preferably used because the resultant toner has good preservability and good running property (i.e., the toner can stably produce high quality images even under high temperature and high humidity conditions).

The added amount of the dispersant is determined depending on the added amount of the pigment, and is preferably from 0.5 to 5 parts by weight per 100 parts by weight of the binder resin in view of the preservability of the toner and running property thereof under high temperature and high humidity conditions.

The dispersant mixed with a pigment has a particulate form, and preferably has an average particle diameter of from 5 to 20 μm so as to be well adsorbed to the pigment used.

Although the dispersant for use in the toner preparation method has releasability, waxes serving as release agents can also be used as toner components. Specific examples of the waxes include natural waxes such as animal waxes (e.g., bees waxes, whale waxes and shellac waxes), vegetable waxes (e.g., carnauba waxes, Japan waxes, rice waxes and candelilla waxes), petroleum waxes (e.g., paraffin waxes and microcrystalline waxes), and mineral waxes (e.g., montan waxes and ozokerite); synthesized waxes such as Fischer Tropsch waxes, polyethylene waxes, oil and fat based synthesis waxes (esters, ketones and amides), and hydrogenated waxes; etc. It is preferable for the waxes for use in the toner that the endothermic peak of the differential scanning calorimetry (DSC) curve thereof is observed at a temperature of from 80 to 110° C. Although the composition of the waxes for use in the present invention is not particularly limited, synthesized hydrocarbon waxes, and petroleum waxes are preferably used. Synthesized hydrocarbon waxes are broadly classified into two types, one of which is Fischer Tropsch waxes, which are prepared by reacting carbon dioxide with hydrogen. The other type is polyethylene waxes which are prepared by polymerizing ethylene or thermally decomposing polyethylene.

The toner prepared by the method of the present invention can optionally include a charge controlling agent to control the frictional charging property of the toner. Charge controlling agents are classified into positive charge controlling agents and negative charge controlling agents. Specific examples of the positive charge controlling agents include basic nitrogen-containing organic compounds (e.g., basic dyes, quaternary ammonium salts, aminopilin, pyrimidine compounds, polynuclear polyamine compounds, aminosilane compounds, and Nigrosine base, etc. Specific examples of the negative charge controlling agents include oil-soluble dyes (e.g., oil blacks and spiropyran), metal-containing azo dyes, naphthenic acid metal salts, alkylsalicylic acid metal salts, fatty acid soaps, resin acid soaps, etc.

The added amount of the charge controlling agent is from 0.1 to 10 parts by weight, and preferably from 0.5 to 8 parts by weight, per 100 parts by weight of the binder resin included in the toner. It is preferable (but is not essential) to use colorless charge controlling agents for color toners. Specific examples of such colorless charge controlling agents include quaternary ammonium salts and alkylsalicylic acid metal salts.

The toner prepared by the method of the present invention can optionally include an external additive, which is typically present on the surface of toner particles. Namely, an external additive is optionally mixed with toner particles prepared by the toner preparation method. Specific examples of such external additives include particulate inorganic and organic materials such as fatty acid metal salts (e.g., zinc stearate, calcium stearate and lead stearate), zinc oxide, aluminum oxide, titanium oxide and silica; particulate resins such as melamine resins.

The average particle diameter of the toner particles prepared by the method of the present invention (i.e., prepared by performing first and second mixing, kneading the toner component mixture, pulverizing the kneaded mixture and classifying the pulverized particles) is preferably from 3 to 15 μm. In order to produce high quality images, the average particle diameter of the toner particles is preferably from 3 to 9 μm, and more preferably from 5 to 8 μm. As mentioned above, the thus prepared toner particles are optionally mixed with an external additive as mentioned above.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

The following toner components were mixed for 5 minutes using a HENSCHEL MIXER mixer to prepare a first mixture.

| | |
|---|---|
| C.I. Pigment Blue 15:3 | 6 parts |
| Montanic acid ester | 2.5 parts |
| (melting point of 83° C., acid value of 19 mgKOH/g, | |
| volume average particle diameter (Dv) of 10 μm) | |

In this first mixing process, the rotor of the mixer was rotated at a revolution of 1500 rpm (revolution per minute).

Next, the following components were mixed using a HENSCHEL MIXER mixer for 5 minutes to prepare a second mixture.

| | | |
|---|---|---|
| First mixture prepared above | 8.5 | parts |
| Polyester resin | 100 | parts |
| (softening point of 105° C., an acid value of 15.3) | | |
| Charge controlling agent | 2 | parts |
| (BONTRON E-84 from Orient | | |
| Chemical Industries Co., Ltd.) | | |
| Paraffin wax | 2 | parts |
| (HNP-9 from Nippon Seiro Co., | | |
| Ltd., serving as a release agent) | | |

In this second mixing process, the rotor of the mixer was rotated at a revolution of 1500 rpm (revolution per minute).

The thus prepared second mixture was kneaded using a continuous open roll kneader (MOS160-560 from Mitsui Mining Co., Ltd.). The kneading conditions were as follows:
Revolution of heat roller: 75 rpm
Revolution of cooling roller: 60 rpm
Revolution Ratio: 1.25 (75/60)
Temperature of heat roller: 120° C.
Temperature of cooling roller: 30° C.

After being cooled, the kneaded mixture was pulverized and classified to prepare toner particles having a volume average particle diameter of 7 μm.

The thus prepared toner particles were mixed with 1.5 parts of hydrophobic silica (RX200 from Nippon Aerosil Co.) serving as an external additive using a 20-litter HENSCHEL MIXER mixer. The mixing conditions were as follows:

Revolution of rotor: 2500 rpm

Mixing time: 5 minutes

The thus prepared toner of Example 1 was evaluated as follows.

### 1. Running Test Under High Temperature and High Humidity Conditions

Four (4) parts of the toner was mixed with 96 parts of a ferrite carrier having a volume average particle diameter of 60 μm and the mixture was agitated for 20 minutes to prepare a two-component developer.

The two-component developer was set in a copier (IMAGIO NEO C355 from Ricoh Co., Ltd.), and 50,000 copies (color images) of an original image having an image area proportion of 5% were continuously produced under high temperature and high humidity conditions of 35° C. and 80% RH. The background densities of the first copy and the 50,000^{th} copy were measured with a reflection densitometer (from Macbeth Co.), which was modified to be able to measure the density to three places of decimals. In addition, the density of an unused sheet of the receiving material (i.e., blank background density), which is not used for image formation, was also measured to determine the density difference (i.e., background density difference) between each of the background densities and the blank background density of the receiving material, i.e., to evaluate the background development property of the toner.

The background development property of the toner was classified into the following four grades:
⊚: The background density difference is not higher than 0.01.
◯: The background density difference is higher than 0.01 and not higher than 0.02.
Δ: The background density difference is higher than 0.02 and not higher than 0.03 (usable level).
×: The background density difference is higher than 0.03 (unusable level).

### 2. Color Tone and Image Density

The two-component developer prepared in paragraph 1 above was set in a full color copier (IMAGIO NEC C600 from Ricoh Co., Ltd.) to produce a toner image having a weight of 0.4 mg/cm² on a sheet of a plain paper for full color image formation (TYPE 6000-70W from Ricoh Co., Ltd.). The color toner image was fixed to the sheet using the fixing device of the full color copier, which had been modified so as to freely change the fixing temperature and which was set outside the copier. In this regard, the fixing temperature was 170° C. The light reflection property of the fixed color toner image was measured using a spectrophotometer (UV3100 from Shimadzu Corp.) to evaluate the color tone and chroma of the color image (i.e., to evaluate the sharpness of the rising portion of the reflection peak, the reflectance, the wavelength at which the reflection peak is observed, and the difference between the absorption peak and the reflection peak).

The color tone and chroma properties of the toner were classified into the following four grades:
⊚: The color tone and chroma properties are excellent.
◯: The color tone and chroma properties are good.
Δ: The color tone and chroma properties are slightly bad (usable level).
×: The color tone and chroma properties are bad (unusable level)

In addition, the image density of the fixed color image was measured with the reflection densitometer mentioned above.

The image density property of the toner was classified into the following four grades:
⊚: The image density is not lower than 1.50.
◯: The image density is lower than 1.50 and not lower than 1.40.
Δ: The image density is lower than 1.40 and not lower than 1.30 (usable level).
×: The image density is lower than 1.30 (unusable level).

### Examples 2 to 27 and Comparative Examples 1 to 2

The procedure for preparation and evaluation of the toner of Example 1 was repeated except that the toner components of the toner were changed as illustrated in Tables 1-1 and 1-2.

### Comparative Example 3

The procedure for preparation and evaluation of the toner of Example 1 was repeated except that all the toner components (i.e., pigment, dispersant, binder resin, charge controlling agent and release agent) were mixed at the same time.

The evaluation results are shown in Table 2.

TABLE 1-1

| | First mixing process | | | | | | |
|---|---|---|---|---|---|---|---|
| | Pigment | | Dispersant | | | | |
| | | Added | | | Added | Acid | |
| | C.I. | Amount | | mp | Amount | Value | |
| | Name | (parts) | Composition | (° C.) | (parts) | (mgKOH/g) | Dv (μm) |
| Ex. 1 | C.I. | 6 | Montanic | 83 | 2.5 | 19 | 10 |
| | Pigment | | acid | | | | |
| | Blue | | ester | | | | |
| | 15:3 | | | | | | |
| Ex. 2 | C.I. | 6 | Montanic | 103 | 2.5 | 19 | 10 |
| | Pigment | | acid | | | | |
| | Blue | | ester | | | | |
| | 15:3 | | | | | | |
| Ex. 3 | C.I. | 6 | Montanic | 75 | 2.5 | 19 | 10 |
| | Pigment | | acid | | | | |
| | Blue | | ester | | | | |
| | 15:3 | | | | | | |
| Ex. 4 | C.I. | 6 | Montanic | 83 | 1.0 | 19 | 10 |
| | Pigment | | acid | | | | |
| | Blue | | ester | | | | |
| | 15:3 | | | | | | |
| Ex. 5 | C.I. | 6 | Montanic | 83 | 5.0 | 19 | 10 |
| | Pigment | | acid | | | | |
| | Blue | | ester | | | | |
| | 15:3 | | | | | | |
| Ex. 6 | C.I. | 6 | Montanic | 83 | 2.5 | 7.2 | 10 |
| | Pigment | | acid | | | | |
| | Blue | | ester | | | | |
| | 15:3 | | | | | | |
| Ex. 7 | C.I. | 6 | Montanic | 83 | 2.5 | 28.5 | 10 |
| | Pigment | | acid | | | | |
| | Blue | | ester | | | | |
| | 15:3 | | | | | | |
| Ex. 8 | C.I. | 6 | Montanic | 83 | 2.5 | 19 | 6.8 |
| | Pigment | | acid | | | | |
| | Blue | | ester | | | | |
| | 15:3 | | | | | | |
| Ex. 9 | C.I. | 6 | Montanic | 83 | 2.5 | 19 | 19 |
| | Pigment | | acid | | | | |
| | Blue | | ester | | | | |
| | 15:3 | | | | | | |
| Ex. 10 | C.I. | 6 | Montanic | 83 | 2.5 | 19 | 10 |
| | Pigment | | acid | | | | |
| | Blue | | ester | | | | |
| | 15:3 | | | | | | |
| Ex. 11 | C.I. | 6 | Montanic | 83 | 2.5 | 19 | 10 |
| | Pigment | | acid | | | | |
| | Blue | | ester | | | | |
| | 15:3 | | | | | | |
| Ex. 12 | C.I. | 13 | Montanic | 83 | 2.5 | 19 | 10 |
| | Pigment | | acid | | | | |
| | Red 122 | | ester | | | | |
| Ex. 13 | C.I. | 6 | Montanic | 83 | 2.5 | 19 | 10 |
| | Pigment | | acid | | | | |
| | Yellow | | ester | | | | |
| | 74 | | | | | | |
| Ex. 14 | C.I. | 6 | Montanic | 110 | 2.5 | 19 | 10 |
| | Pigment | | acid | | | | |
| | Blue | | ester | | | | |
| | 15:3 | | | | | | |
| Ex. 15 | C.I. | 6 | Montanic | 110 | 2.5 | 19 | 10 |
| | Pigment | | acid | | | | |
| | Blue | | ester | | | | |
| | 15:3 | | | | | | |
| Ex. 16 | C.I. | 6 | Stearic | 67 | 2.5 | 19 | 10 |
| | Pigment | | acid | | | | |
| | Blue | | ester | | | | |
| | 15:3 | | | | | | |
| Ex. 17 | C.I. | 6 | Montanic | 83 | 0.5 | 19 | 10 |
| | Pigment | | acid | | | | |
| | Blue | | ester | | | | |
| | 15:3 | | | | | | |
| Ex. 18 | C.I. | 6 | Montanic | 83 | 7.0 | 19 | 10 |
| | Pigment | | acid | | | | |
| | Blue | | ester | | | | |
| | 15:3 | | | | | | |
| Ex. 19 | C.I. | 6 | Montanic | 83 | 2.5 | 3.5 | 10 |
| | Pigment | | acid | | | | |
| | Blue | | ester | | | | |
| | 15:3 | | | | | | |
| Ex. 20 | C.I. | 6 | Montanic | 83 | 2.5 | 32.4 | 10 |
| | Pigment | | acid | | | | |
| | Blue | | ester | | | | |
| | 15:3 | | | | | | |
| Ex. 21 | C.I. | 6 | Montanic | 83 | 2.5 | 19 | 5 |
| | Pigment | | acid | | | | |
| | Blue | | ester | | | | |
| | 15:3 | | | | | | |
| Ex. 22 | C.I. | 6 | Montanic | 83 | 2.5 | 19 | 25 |
| | Pigment | | acid | | | | |
| | Blue | | ester | | | | |
| | 15:3 | | | | | | |
| Ex. 23 | C.I. | 6 | Montanic | 83 | 2.5 | 19 | 10 |
| | Pigment | | acid | | | | |
| | Blue | | ester | | | | |
| | 15:3 | | | | | | |
| Ex. 24 | C.I. | 6 | Montanic | 83 | 2.5 | 19 | 10 |
| | Pigment | | acid | | | | |
| | Blue | | ester | | | | |
| | 15:3 | | | | | | |
| Ex. 25 | C.I. | 6 | Montanic | 83 | 2.5 | 19 | 10 |
| | Pigment | | acid | | | | |
| | Blue 16 | | ester | | | | |
| Ex. 26 | C.I. | 6 | Montanic | 83 | 2.5 | 19 | 10 |
| | Pigment | | acid | | | | |
| | Red 269 | | ester | | | | |
| Ex. 27 | C.I. | 6 | Montanic | 83 | 2.5 | 19 | 10 |
| | Pigment | | acid | | | | |
| | Yellow | | ester | | | | |
| | 93 | | | | | | |
| Comp. | C.I. | 7 | Montanic | 83 | 2.5 | 19 | 10 |
| Ex. 1 | Pigment | | acid | | | | |
| | Blue | | ester | | | | |
| | 15:3 | | | | | | |
| Comp. | C.I. | 6 | Oxidized | 76 | 2.5 | 19 | 10 |
| Ex. 2 | Pigment | | Paraffin | | | | |
| | Blue | | wax | | | | |
| | 15:3 | | | | | | |
| Comp. | C.I. | 6 | Montanic | 83 | 2.5 | 19 | 10 |
| Ex. 3 | Pigment | | acid | | | | |
| | Blue | | ester | | | | |
| | 15:3 | | | | | | |

Note:
mp: melting point
Dv: Volume average particle diameter

TABLE 1-2

| | Second mixing process | | | | |
|---|---|---|---|---|---|
| | Binder resin | | | | |
| | | Softening | Acid | Charge | |
| | | Point | value | controlling | Release |
| | Composition | (° C.) | (mgKOH/g) | agent | agent |
| Ex. 1 | Polyester | 105 | 15.3 | BONTRON | HNP-9 |
| | resin | | | E-84 | |
| Ex. 2 | Polyester | 120 | 15.3 | BONTRON | ″ |
| | resin | | | E-84 | |
| Ex. 3 | Polyester | 105 | 15.3 | BONTRON | ″ |
| | resin | | | E-84 | |
| Ex. 4 | Polyester | 105 | 15.3 | BONTRON | ″ |
| | resin | | | E-84 | |
| Ex. 5 | Polyester | 105 | 15.3 | BONTRON | ″ |
| | resin | | | E-84 | |
| Ex. 6 | Polyester | 105 | 15.3 | BONTRON | ″ |
| | resin | | | E-84 | |
| Ex. 7 | Polyester | 105 | 15.3 | BONTRON | ″ |
| | resin | | | E-84 | |
| Ex. 8 | Polyester | 105 | 15.3 | BONTRON | ″ |
| | resin | | | E-84 | |
| Ex. 9 | Polyester | 105 | 15.3 | BONTRON | ″ |
| | resin | | | E-84 | |
| Ex. 10 | Polyester | 105 | 5.5 | BONTRON | ″ |
| | resin | | | E-84 | |
| Ex. 11 | Polyester | 105 | 27.5 | BONTRON | ″ |
| | resin | | | E-84 | |
| Ex. 12 | Polyester | 105 | 15.3 | BONTRON | ″ |
| | resin | | | E-84 | |
| Ex. 13 | Polyester | 105 | 15.3 | BONTRON | ″ |
| | resin | | | E-84 | |
| Ex. 14 | Polyester | 105 | 15.3 | BONTRON | ″ |
| | resin | | | E-84 | |
| Ex. 15 | Polyester | 120 | 15.3 | BONTRON | ″ |
| | resin | | | E-84 | |
| Ex. 16 | Polyester | 105 | 15.3 | BONTRON | ″ |
| | resin | | | E-84 | |
| Ex. 17 | Polyester | 105 | 15.3 | BONTRON | ″ |
| | resin | | | E-84 | |
| Ex. 18 | Polyester | 105 | 15.3 | BONTRON | ″ |
| | resin | | | E-84 | |
| Ex. 19 | Polyester | 105 | 15.3 | BONTRON | ″ |
| | resin | | | E-84 | |
| Ex. 20 | Polyester | 105 | 15.3 | BONTRON | ″ |
| | resin | | | E-84 | |
| Ex. 21 | Polyester | 105 | 15.3 | BONTRON | ″ |
| | resin | | | E-84 | |
| Ex. 22 | Polyester | 105 | 15.3 | BONTRON | ″ |
| | resin | | | E-84 | |
| Ex. 23 | Polyester | 105 | 4.3 | BONTRON | ″ |
| | resin | | | E-84 | |
| Ex. 24 | Polyester | 105 | 31.3 | BONTRON | ″ |
| | resin | | | E-84 | |
| Ex. 25 | Polyester | 105 | 15.3 | BONTRON | ″ |
| | resin | | | E-84 | |
| Ex. 26 | Polyester | 105 | 15.3 | BONTRON | ″ |
| | resin | | | E-84 | |
| Ex. 27 | Polyester | 105 | 15.3 | BONTRON | ″ |
| | resin | | | E-84 | |
| Comp. | Styrene- | 105 | 5.8 | BONTRON | ″ |
| Ex. 1 | acrylic | | | E-84 | |
| | resin | | | | |
| Comp. | Polyester | 105 | 15.3 | BONTRON | ″ |
| Ex. 2 | resin | | | E-84 | |
| Comp. | Polyester | 105 | 15.3 | BONTRON | ″ |
| Ex. 3* | resin | | | E-84 | |

Note:
In Comparative Example 3, all the toner components (the pigment, dispersant, binder resin, charge controlling agent and release agent) were mixed at the same time (i.e., in the first mixing process).

TABLE 2

| | Running test | | | | | | | |
|---|---|---|---|---|---|---|---|---|
| | (35° C. 85% RH) | | | | | | | |
| | Background | | Background | | | | | |
| | development | | development | | | | | |
| | of first | | Of 50,000^{th} | | | Image | | |
| | image | | image | | | density | | Overall |
| | GD | Grade | GD | Grade | Color tone | Value | Grade | evaluation |
| Ex. 1 | 0.004 | ⊚ | 0.008 | ⊚ | ⊚ | 1.52 | ⊚ | ⊚ |
| Ex. 2 | 0.002 | ⊚ | 0.004 | ⊚ | ◯ | 1.41 | ◯ | ⊚ |
| Ex. 3 | 0.007 | ⊚ | 0.013 | ◯ | ⊚ | 1.55 | ⊚ | ⊚ |
| Ex. 4 | 0.003 | ⊚ | 0.005 | ⊚ | ◯ | 1.43 | ◯ | ⊚ |
| Ex. 5 | 0.011 | ◯ | 0.018 | ◯ | ⊚ | 1.56 | ⊚ | ⊚ |
| Ex. 6 | 0.002 | ⊚ | 0.004 | ⊚ | ◯ | 1.41 | ◯ | ⊚ |
| Ex. 7 | 0.013 | ◯ | 0.018 | ◯ | ⊚ | 1.56 | ⊚ | ⊚ |
| Ex. 8 | 0.008 | ⊚ | 0.012 | ◯ | ◯ | 1.43 | ◯ | ⊚ |
| Ex. 9 | 0.009 | ⊚ | 0.015 | ◯ | ◯ | 1.42 | ◯ | ⊚ |
| Ex. 10 | 0.002 | ⊚ | 0.003 | ⊚ | ◯ | 1.41 | ◯ | ⊚ |
| Ex. 11 | 0.014 | ◯ | 0.019 | ◯ | ⊚ | 1.52 | ⊚ | ⊚ |
| Ex. 12 | 0.004 | ⊚ | 0.007 | ⊚ | ⊚ | 1.50 | ⊚ | ⊚ |
| Ex. 13 | 0.003 | ⊚ | 0.007 | ⊚ | ⊚ | 1.53 | ⊚ | ⊚ |
| Ex. 14 | 0.004 | ⊚ | 0.006 | ⊚ | Δ | 1.37 | Δ | ◯ |
| Ex. 15 | 0.003 | ⊚ | 0.006 | ⊚ | Δ | 1.36 | Δ | ◯ |
| Ex. 16 | 0.021 | Δ | 0.027 | Δ | ⊚ | 1.59 | ⊚ | ◯ |
| Ex. 17 | 0.002 | ⊚ | 0.005 | ⊚ | Δ | 1.34 | Δ | ◯ |
| Ex. 18 | 0.023 | Δ | 0.028 | Δ | ⊚ | 1.60 | ⊚ | Δ |
| Ex. 19 | 0.002 | ⊚ | 0.004 | ⊚ | Δ | 1.33 | Δ | ◯ |
| Ex. 20 | 0.025 | Δ | 0.029 | Δ | ⊚ | 1.59 | ⊚ | ◯ |
| Ex. 21 | 0.013 | ◯ | 0.017 | ◯ | Δ | 1.35 | Δ | ◯ |
| Ex. 22 | 0.014 | ◯ | 0.019 | ◯ | Δ | 1.36 | Δ | ◯ |
| Ex. 23 | 0.002 | ⊚ | 0.003 | ⊚ | Δ | 1.35 | Δ | ◯ |
| Ex. 24 | 0.015 | ◯ | 0.021 | Δ | ⊚ | 1.58 | ⊚ | ◯ |
| Ex. 25 | 0.004 | ⊚ | 0.006 | ⊚ | Δ | 1.56 | ⊚ | ◯ |
| Ex. 26 | 0.005 | ⊚ | 0.006 | ⊚ | Δ | 1.55 | ⊚ | ◯ |
| Ex. 27 | 0.004 | ⊚ | 0.007 | ⊚ | Δ | 1.48 | ◯ | ◯ |
| Comp. | 0.006 | ⊚ | 0.008 | ⊚ | X | 1.29 | X | X |
| Ex. 1 | | | | | | | | |
| Comp. | 0.015 | ◯ | 0.018 | ◯ | X | 1.28 | X | X |
| Ex. 2 | | | | | | | | |
| Comp. | 0.013 | ◯ | 0.018 | ◯ | X | 1.28 | X | X |
| Ex. 3* | | | | | | | | |

Note:
GD: Background density difference

It is clear from Table 2 that the toners of Examples 1 to 13 have good environmental stability, and a good combination of color tone and tinting power (image density) because the pigment is well dispersed in the toners.

The color tone and tinting power of the toner of Example 14 are inferior to those of the toners of Examples 1 to 13, but are still on a usable level. This is because the melting point of the dispersant is higher than the softening point of the binder resin, and thereby dispersion of the pigment is slightly deteriorated.

The color tone and tinting power of the toner of Example 15 are inferior to those of the toners of Examples 1 to 13, but are still on a usable level. This is because the melting point of the dispersant is high (110° C.), and thereby dispersion of the pigment is slightly deteriorated.

The environmental stability (i.e., charging property (background development property) under high temperature and high humidity conditions) of the toner of Example 16 is inferior to those of the toners of Examples 1 to 13, but is still on a usable level. This is because the melting point of the dispersant is low (67° C.).

The color tone and tinting power of the toners of Examples 17, 19 and 23 are inferior to those of the toners of Examples 1 to 13, but are still on a usable level. This is because the added amount of the dispersant is low, the acid value thereof is low, or the acid value of the binder resin is low.

In contrast, the color tone and tinting power of the toners of Examples 18, 20 and 24 are good because the added amount and the acid value of the dispersant, and the acid value of the binder resin are high. However, the environmental stability thereof is inferior to those of the toners of Examples 1 to 13, but is still on a usable level.

The color tone and tinting power of the toners of Examples 21 and 22 are inferior to those of the toners of Examples 1 to 13, but are still on a usable level. In addition, the environmental stability of the toners is slightly inferior to that of the toner of Example 1. This is because the particle diameter of the dispersant is too small or too large, and thereby the pigment cannot be sufficiently dispersed.

The color tone of the toners of Example 25 to 27 is inferior to those of the toners of Examples 1 to 13, but is still on a usable level. This is because the colorant is different. Specifically, the colorant of the toner of Example 25 has lower chroma, and the color tones of the colorants used for the toners of Examples 26 and 27 are slightly different from the targeted magenta and yellow color tones.

The toners of Comparative Examples 1 to 3 have poor color tone and tinting power (low image density) because the pigment is not well dispersed therein.

This document claims priority and contains subject matter related to Japanese Patent Application No. 2008-066968, filed on Mar. 17, 2008, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by letters patent of the United States is:

1. A method for preparing a toner including as toner components at least a binder resin, a pigment and a dispersant for the pigment, comprising:
firstly mixing at least the pigment and the dispersant to prepare a first mixture;
secondly mixing the first mixture with other toner components including at least the binder resin to prepare a second mixture;
kneading the second mixture using an open roll kneader;
pulverizing the kneaded second mixture to prepare a colored powder; and
classifying the colored powder to prepare particles of the toner,
wherein the binder resin includes a polyester resin, and the dispersant includes a fatty acid ester.

2. The method according to claim 1, wherein the dispersant has a melting point lower than a softening point of the binder resin.

3. The method according to claim 1, wherein the dispersant has a melting point of from 70 to 105° C.

4. The method according to claim 1, wherein a weight ratio of the dispersant to the binder resin is from 0.5/100 to 5/100.

5. The method according to claim 1, wherein the dispersant has an acid value of from 5 to 30 mgKOH/g.

6. The method according to claim 1, wherein the first mixing step comprises:
firstly mixing at least the pigment and the dispersant having a volume average particle diameter of from 5 to 20 μm to prepare a first mixture.

7. The method according to claim 1, wherein the binder resin has an acid value of from 5 to 30 mgKOH/g.

8. The method according to claim 1, wherein the toner is a magenta toner and the pigment is C.I. Pigment Red 122.

9. The method according to claim 1, wherein the toner is a cyan toner and the pigment is C.I. Pigment Blue 15.

10. The method according to claim 1, wherein the toner is a yellow toner and the pigment is C.I. Pigment Yellow 74.
